(19) United States
(12) Patent Application Publication
(10) Pub. No.: US 2008/0200088 A1
(43) Pub. Date: Aug. 21, 2008

(54) Method for reducing interference fringes in a display device

(76) Inventors: Chong Pyung An, Painted Post, NY (US); Aiyu Zhang, Mason, OH (US)

Correspondence Address: CORNING INCORPORATED, SP-TI-3-1, CORNING, NY, 14831, US

(21) Appl. No.: 11/708,809

(22) Filed: Feb. 21, 2007

(51) Int. Cl. H01J 9/26

(52) U.S. Cl. 445/25

(57) ABSTRACT

A method of minimizing the formation of interference fringes in an OLED display device is disclosed comprising sealing the upper and lower glass substrates comprising the display device to one another within an enclosure wherein a pressure of the atmosphere within the enclosure is greater than the pressure of the atmosphere outside the enclosure.

### BACKGROUND OF THE INVENTION

1. Field of the Invention

The present invention is directed to a method of reducing sag-induced Newton's rings in a display device, and in particular, Newton's rings in an organic light emitting diode (OLED) display device.

2. Technical Background

Organic light emitting diodes (OLEDs) hold considerable promise as an alternative display device technology to, for example, liquid crystal or plasma displays. Advantages to OLED displays include a thin form factor, low power consumption, wide color gamut, high contrast ratio, wide viewing angle, fast response time and low temperature manufacturing.

An OLED display device typically comprises a first, backplane substrate and a second, cover substrate. An OLED element comprising one or more layers of organic light emitting material and one or more electrodes is disposed on the backplane substrate, and sandwiched between the backplane and cover substrates. The backplane substrate is hermetically sealed to the cover substrate, thus encapsulating the OLED element between the two substrates. The backplane substrate may be sealed to the cover substrate using a variety of methods, including the use of an adhesive, such as an epoxy adhesive, or by forming a frit seal. The use of a frit is a favored approach due to the long-lived hermeticity of the resultant seal. Frit seals tend to require less separation between the backplane and cover substrates, and are self supporting during the sealing process, whereas adhesive seals tend to require spacers to maintain a consistent separation between the backplane and cover substrates.

One drawback to having a small distance between the cover substrate and the OLED element is the potential for forming interference fringes on the viewing surface of the display device under fluorescence light if the cover substrate exhibits sag. In some cases, the magnitude of the sag may be sufficient to cause contact between the cover and the OLED element, which may damage the OLED element. The formation of interference fringes is a well-known optical phenomenon which occurs in the gas film between closely spaced transparent media having a varying separation, such as, for example, the air film between the convex spherical surface of a lens and a planar glass surface in contact with the lens. It is known more popularly by the name Newton's rings. The rings or interference fringes form alternating light (constructive interference) and (lark (destructive interference) fringes about the point of contact between the lens and the planar surface.

Newton's rings appear in an OLED display device when a glass substrate which serves as a transparent window for the display sags into close proximity of an organic electroluminescent element within the device. This sagging may result from the manufacturing process. For example, in some processes a force may be applied to the cover substrate when sealing the cover substrate to the backplane substrate having the OLED element disposed thereon in order to obtain a good seal. If this sealing force is applied unevenly, creating a depressed region in the center portion of the cover substrate, interference fringes may appear. A display device which exhibits interference fringes is commercially unacceptable.

What is needed is a method of forming a hermetic seal in an OLED device while minimizing sag and avoiding the formation of interference fringes in the sealed device.

### SUMMARY

In accordance with an embodiment of the present invention, a method of minimizing interference fringes in a display device is provided comprising providing first and second substrates, the first substrate comprising an organic light emitting diode (OLED) element disposed thereon, sealing the second substrate to the first substrate, the OLED element being disposed between the first and second substrates, and wherein the sealing is performed in an enclosure comprising an atmosphere with a pressure Pᵢₙ greater than a pressure Pₒᵤₜ of an ambient atmosphere outside the enclosure.

It is desirable that the pressure (Pᵢₙ) of the atmosphere inside the enclosure during the sealing is greater than the pressure (Pₒᵤₜ) outside the enclosure by at least about 10 mbar. That is, wherein Pᵢₙ−Pₒᵤₜ≧10 mbar. Put another way, it is desirable that Pᵢₙ is equal to or greater than about 1.01*Pₒᵤₜ. In some embodiments, it may be desirable to have Pᵢₙ≧1.013*Pₒᵤₜ.

In another embodiment, a method of minimizing interference fringes in a display device is disclosed comprising providing first and second substrates, the first substrate comprising an organic light emitting diode (OLED) element disposed thereon, sealing the second substrate to the first substrate, the OLED element being disposed between the first and second substrates, and wherein the sealing is performed in an enclosure comprising an atmosphere with a pressure Pᵢₙ equal to or greater than (S₀/8h_{f})/(1−(S₀/8h_{f})) times the pressure Pₒᵤₜ of an ambient atmosphere outside the enclosure, where h_{f} is the separation between the first and second substrates by frit and S₀ is a maximum sag of the second substrate.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate an exemplary embodiment of the invention and, together with the description, serve to explain the principles and operations of the invention.

### BRIEF DESCRIPTION OF THE DRAWINGS

FIG. 1 is a side cross sectional view of an OLED device exhibiting sag. The OLED device is shown disposed in an enclosure.

FIG. 2 is a side cross sectional view of a glass envelope (an LED device without an OLED element), showing several forms of cover substrate sag.

FIG. 3 is a plot of the minimum differential pressure desired between the inside of the enclosure (e.g. glove box) as a function of the number of fringes by which the visible fringe pattern is desired to be reduced.

### DETAILED DESCRIPTION

In the following detailed description, for purposes of explanation and not limitation, example embodiments disclosing specific details are set forth to provide a thorough understanding of the present invention. However, it will be apparent to one having ordinary skill in the art, having had the benefit of the present disclosure, that the present invention may be practiced in other embodiments that depart from the specific details disclosed herein. Moreover, descriptions of well-known devices, methods and materials may be omitted so as not to obscure the description of the present invention. Finally, wherever applicable, like reference numerals refer to like elements.

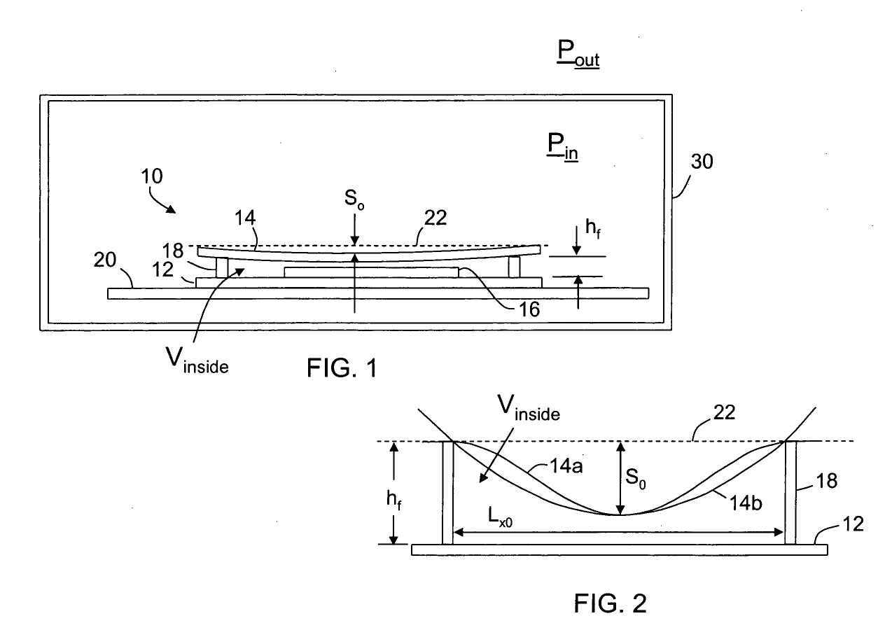

Shown in FIG. 1 is an OLED device 10 that exhibits sag. OLED device 10 comprises first (backplane) substrate 12, second (cover) substrate 14, and OLED element 16 disposed therebetween. OLED element 16 in turn comprises one or more organic electroluminescent layers, as well as metal oxide electrode layers. First and second substrates 12, 14 are separated by frit wall 18 having a height h_{F} and arranged about a periphery of the substrates in the form of a closed circuit or frame. The parameter h_{f} is equivalent to the separation between the first and second substrates after sealing the substrates.

Backplane substrate 12 is assumed to be flat. Flattening of the backplane substrate may be accomplished, for example, by supporting it with a flat, hard supporting fixture 20. As illustrated in FIG. 1, cover substrate 14 exhibits an inward sag, where S₀ is the sag amplitude at the center of the cover substrate (relative to the frit wall height), and Lₓ₀ (or L_{y0}) is the x-(or y-)dimension of the frit wall, and V_{inside} is the volume confined by the first and second substrates and the frit wall after sealing (see FIG. 2). Dashed line 22 represents a plane parallel to backplane substrate 12, and therefore a reference position for cover substrate 14 (the position of substrate 14 if sag were not present).

In a simplified form (e.g. not considering internal stress in the cover sheet, or a non-uniform frit wall height h_{f}), cover substrate sag can be represented as a parabolic or sine function. In FIG. 2, reference numeral 14a identifies a parabolic sag in the cover substrate, and reference numeral 14b identifies a sine-function sag in the cover substrate. (FIG. 2 is shown without OLED element 16 for clarity.) Since backplane substrate 12 is assumed flat, the backplane substrate can be represented by the equation f_{Bottom}(x,y)=0. For an assumed parabolic sag, the cover substrate can be represented by the equation,

$${f}_{Parabolic} ( x , y ) = {h}_{F} - {S}_{0} \cdot \{ ( \frac{16}{{L}_{x 0}^{2} {L}_{y 0}^{2}} ) \cdot ( {x}^{2} - {L}_{x 0} x ) \cdot ( {y}^{2} - {L}_{y 0} y ) \} \qquad ( 1 )$$

where h_{F} is the frit wall height after sealing, S₀ is the maximum sag amplitude, and Lₓ₀ and L_{y0} are the dimensions of the frit perimeter in the x- and y-directions, respectively.

Similarly, for a sine-shaped sag, the cover substrate can be represented by the equation

$${f}_{Sine \text{-} shape} ( x , y ) = {h}_{F} - {S}_{0} \cdot {sin}^{2} ( \frac{π x}{{L}_{x 0}} ) \cdot {sin}^{2} ( \frac{π y}{{L}_{y 0}} ) \qquad ( 2 )$$

where the parameters are the same as in (1) above.

The volume confined after laser frit sealing, V_{Inside}, is calculated by integrating the above sag-shape functions such that they may be expressed as a simple equation with a parameter α

V_{Inside}=A·(h_{F}−αS₀) (3)

where A is the sealed area on the bottom plate (that is, A=Lₓ₀·L_{y0} for a rectangular backplane substrate) and α is the sag volume parameter. By sealed area what is meant is the area of backplane substrate 12 enclosed by frit wall 18. The sag volume parameter α, determined by the sag shape, is equal to 4/9 for the parabolic sag and ¼ for the sine-function sag.

Equation (3) can be used to express the pressure differential between the pressure inside of the glove box and the pressure outside the glove box according to

$$Δ P = {P}_{i n} - {P}_{out} = {P}_{out} \cdot \frac{α ( {S}_{0} / {h}_{F} )}{1 - α ( {S}_{0} / {h}_{F} )} \qquad ( 4 )$$

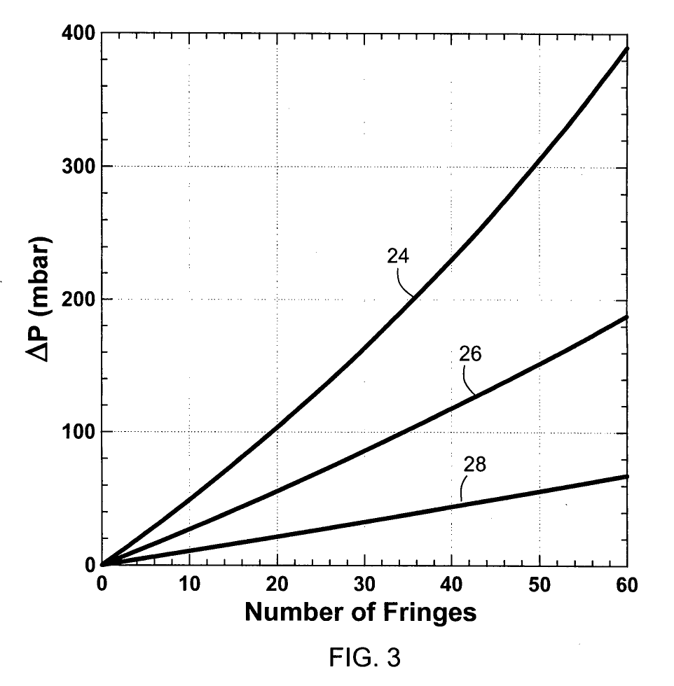

FIG. 3 depicts plotted curves for several different scenarios of cover substrate sag. Curve 24 represents the desired pressure differential ΔP between the glove box inside pressure Pᵢₙ and the ambient atmospheric pressure Pₒᵤₜ outside the glove box as a function of the number of interference fringes in the instance of a cover substrate having a parabolic-shaped sag. Curve 26 represents the desired pressure differential ΔP between the glove box inside pressure Pᵢₙ and the ambient atmospheric pressure Pₒᵤₜ outside the glove box as a function of the number of interference fringes in the instance of a cover substrate having a sine-shaped shaped sag. Finally, curve 28 represents the desired pressure differential ΔP between the glove box inside pressure Pᵢₙ and the ambient atmospheric pressure Pₒᵤₜ outside the glove box as a function of the number of interference fringes based on experimental data collected from an experiment described below. The data from FIG. 3 suggest the desirability of sealing the display device in an atmosphere having a pressure at least ΔP equal to or greater than that represented by curve 28 in FIG. 3. As described herein, this can most easily be accomplished by performing the sealing process within the confines of an enclosure (glove box) 30, such as that shown in FIG. 1. Enclosure 30 should be connected to a pressure control system (not shown) capable of providing the enclosure with an atmosphere comprised of substantially inert gases, and at a pressure greater than the pressure of the ambient atmospheric pressure outside the enclosure. Suitable pressure control systems for maintaining a pre-determined pressure within an enclosure are well understood, and no further description should be necessary.

### EXAMPLE

In an example of the above described process, two frit-sealed glass sample envelopes were manufactured in accordance with an embodiment of the present invention. For the first envelope, sample A, a first SiO₂-based glass substrate having dimensions of 50.8 mm×50.8 mm was hermetically sealed with a frit to a second SiO₂-based glass substrate having the same dimensions. Both substrates were approximately 0.7 mm in thickness. The glass envelope did not contain an OLED element within its interior. To form the envelope, a frit wall was formed by dispensing a glass frit paste onto the second substrate in a closed circuit or frame pattern having dimensions of 40 mm×40 mm. The second substrate comprising the frit frame was then heated in an oven to pre-sinter the frit wall. The frit wall had a height of about 14 μm within ±1 μm. The first substrate was placed on a steel plate in a glove box comprising a substantially nitrogen atmosphere. Subsequent to the pre-sintering, the second substrate was placed on the first substrate in the glove box with the frit wall disposed between the first and second substrates, and a small magnet was placed on top of the second substrate within the perimeter of the frit frame. The pressure of the inert atmosphere within the glove box was raised to a pressure of about 1.4 mbar above the ambient atmospheric pressure outside the glove box, where atmospheric pressure was about 1013 mbar. The frit was the heated and melted by irradiating the frit wall through the second substrate with a laser beam, which was traversed over the frit wall to heat and melt the frit wall and seal the substrates together. The height of the frit wall after sealing was approximately 12 μm. The first sample was then removed from the glove box and inspected for Newton rings. The number of rings was counted from the inside boundary of the frit wall to the center fringe. Approximately 49 fringes were counted.

The same process was used to form a second sample envelope, Sample B, with the exception that the pressure of the atmosphere within the glove box prior to sealing was adjusted to approximately 13 mbar (about 1.28%) above the ambient atmospheric pressure outside the glove box. Again, subsequent to the sealing process, the second sample was removed from the glove box and the number of fringes counted, with approximately 39 fringes counted for the second sample.

To simplify calculations, it was assumed the fringes resulted from the interference of light at a wavelength of about 500 nm, approximately the center of the visible wavelength band. Consequently, one fringe interval (the distance from one constructive fringe to the adjacent constructive fringe) represented a 250 nm change in sag. Since the fringes were counted from the perimeter of the envelope to the center of the envelope, the counted number represented only one half of the total number of fringes across the entire envelope from frit boundary to frit boundary. Thus, the maximum sag for the first, 1.4 mbar ΔP sample was approximately 6 μm and the maximum sag for the second, 13 mbar ΔP sample was approximately 5 μm, resulting in a reduction in sag of about 1 μm.

Assuming a sine-function sag in the samples, the inner volume of sample A, VA is equal to 16.8 mm³ and the inner volume of sample B, V_{B}, was 17.2 mm³, representing a 0.4 mm³ change in inner volume, or an approximately 2.3% change. Using equation (4), a minimum pressure differential between the pressure of the atmosphere inside the glove box and the pressure of the atmosphere outside the glove box according to the present experiment is ΔP≧Pₒᵤₜ*(S₀/8h_{f})/(1−S₀/8h_{f}). That is, α=⅛.

It is believed these experimental results differ from those predicted from theory due to factors such as frit height variation and internal glass stress.

It should be emphasized that the above-described embodiments of the present invention, particularly any “preferred” embodiments, are merely possible examples of implementations, merely set forth for a clear understanding of the principles of the invention. Many variations and modifications may be made to the above-described embodiments of the invention without departing substantially from the spirit and principles of the invention. For example, although the present invention is described in terms of an embodiment employing a frit seal, the teaching of the present invention may be applied in other embodiments where a sufficiently small distance separates the encapsulating substrates, and sag is formed in one of the substrates, resulting in the formation of interference fringes. All such modifications and variations are intended to be included herein within the scope of this disclosure and the present invention and protected by the following claims.

What is claimed is:

1. A method of encapsulating an organic light emitting diode (OLED) device comprising:
providing first and second substrates, the first substrate comprising an OLED element disposed thereon;
sealing the second substrate to the first substrate, the OLED element being disposed between the first and second substrates; and
wherein the sealing is performed in an enclosure comprising an atmosphere with a pressure Pᵢₙ greater than a pressure Pₒᵤₜ of an ambient atmosphere outside the enclosure.

2. The method according to claim 1 wherein Pᵢₙ−Pₒᵤₜ≧10 mbar.

3. The method according to claim 1 wherein Pᵢₙ is equal to or greater than about 1.01*Pₒᵤₜ.

4. The method according to claim 1 wherein the second substrate comprises a frit wall disposed thereon.

5. The method according to claim 4 wherein the sealing comprises heating the frit wall with a laser beam.

6. The method according to claim 1 wherein Pᵢₙ−Pₒᵤₜ≧Pₒᵤₜ*(S₀/8h_{f})/(1−(S₀/8h_{f})) where h_{f} is a height of a frit wall disposed between the first and second substrates and S₀ is a maximum sag of the second substrate.

7. The method according to claim 1 wherein the sealing comprises heating a glass frit disposed between the first and second substrates to melt the frit, thereby forming a hermetic seal between the first and second substrates.

8. The method according to claim 7 wherein the heating is performed by traversing a laser beam over the glass frit.

9. A method of method of encapsulating an organic light emitting diode (OLED) device comprising:
providing first and second substrates, the first substrate comprising an OLED element disposed thereon;
sealing the second substrate to the first substrate such that the OLED element is disposed between the first and second substrates; and
wherein the sealing is performed in an enclosure comprising an atmosphere with a pressure Pᵢₙ equal to or greater than (S₀/8h_{f})/(1−(S₀/8h_{f})) times the pressure Pₒᵤₜ of an ambient atmosphere outside the enclosure, where h_{f} is the separation between the first and second substrates and S₀ is a maximum sag of the second substrate.

10. The method according to claim 9 wherein Pᵢₙ≧Pₒᵤₜ*(S₀/4h_{f})/(1−(S₀/4h_{f})).

11. The method according to claim 9 wherein Pᵢₙ≧Pₒᵤₜ*(4S₀/9h_{f})/(1−(4S₀/9h_{f})).

12. The method according to claim 9 wherein the sealing comprises heating a glass frit with a laser beam.
